(19) United States
(12) Patent Application Publication
(10) Pub. No.: US 2024/0370674 A1
(43) Pub. Date: Nov. 7, 2024

(54) RADIO-FREQUENCY IDENTIFICATION (RFID) BASED IDENTIFICATION FRIEND OR FOE (IFF)

(71) Applicants: MEHMET KAPTANA, IRVINE, CA (US); MEHMET BURAK KUTLUG, IRVINE, CA (US)

(72) Inventors: MEHMET KAPTANA, IRVINE, CA (US); MEHMET BURAK KUTLUG, IRVINE, CA (US)

(21) Appl. No.: 18/231,507

(22) Filed: Aug. 8, 2023

(51) Int. Cl. G06K 7/10

(52) U.S. Cl. CPC G06K 7/10366

(57) ABSTRACT

The present invention belongs to the field of identification systems for command and control, in particular to the field of identification friend or foe (IFF), and discloses radio-frequency identification (RFID) based IFF.

### FIELD OF THE INVENTION

The present invention belongs to the field of identification systems for command and control. Particularly, the present invention belongs to the field of identification friend or foe (IFF). In specific, the present invention discloses radio-frequency identification (RFID) based IFF.

IFF is an identification system designed for command and control. It uses a transponder that listens for an interrogation signal and then sends a response that identifies the broadcaster. IFF systems usually use radar frequencies, but other electromagnetic frequencies, radio or infrared, are also used. IFF enables military and civilian air traffic control interrogation systems to identify aircraft, vehicles or forces as friendly and to determine their bearing and range from the interrogator. IFF is used by both military and civilian aircraft. IFF was first developed during World War II, with the arrival of radar, and several friendly fire incidents.

IFF is a tool within the broader military action of Combat Identification (CID), the characterization of objects detected in the field of combat sufficiently accurately to support operational decisions. The broadest characterization is that of friend, enemy, neutral, or unknown. CID not only can reduce friendly fire incidents, but also contributes to overall tactical decision-making.

### BACKGROUND OF THE INVENTION

Security forces face the following problems in the field:
In every battle at least 2 percent of the soldiers are shot by allies or members of the same army, which is called friendly fire.
Some of the soldiers are not rescued because they are not found in the battle area.
In order to increase the rate of saving soldiers it is vital to obtain the information of the moment of the shooting and the location of soldiers.
While the soldiers are being rescued, prioritization cannot be made remotely according to the probability of being rescued.
Soldiers cannot understand whether their target is an ally or an enemy if their view is unclear or their target is behind a wall or any other object.
Ineffective operation of defense technologies in jammer areas.

U.S. Pat. No. 7,831,150 discloses a combat IFF system, for use in a combat exercise or on the battlefield, including a helmet-mounted passive IFF response unit and a weapon-mounted IFF interrogatory unit for each soldier, further disclosing: “Infrared (IR) signals are employed for both challenge and response. The IR response signal is a very narrowly-targeted reflection of the relatively narrow IR transmit signal, thereby minimizing interception opportunities. The transmit and response signals are encoded in a transaction that cannot be compromised even when either or both signals are intercepted and decoded by the enemy. The combat IFF system includes biometric anti-spoofing features that prevent any use by an enemy in possession of captured units. Military radio-frequency (RF) spectrum is not required so there are no bandwidth limitations on simultaneous IFF transactions in the battlefield. A combat IFF transaction is completed in milliseconds.”

U.S. Pat. No. 6,166,679 discloses a friend or foe detection system and method and further discloses: “Friend or foe warning unit 20 has a geographic locating system, a communication system for communicating with each of the warning units, and a military force detection system for detecting military forces in a combat area and has a signal routing and control circuitry 50 for controlling operations. A number of components, devices, or sub-systems, such as a transmitter receiver radio 28, an antenna 26, a microphone 30, a speaker 32, a battery 34, a display 36, a microprocessor 38, a memory 40, a camera 56, a radar/lidar input 54, on/off switch 52, a GPS location system 45 that includes a GPS processor 46, a GPS receiver 42, a GPS antenna 44, are coupled to the circuitry 50. Display 36 provides a display to the user of the unit 20 and shows the location of friendly forces as well as unfriendly or unidentified forces in the area. Display 36 displays text messages for the user of the warning unit 20. The microprocessor 38 together with memory 40 provide microprocessor control of the operations of the warning unit 20. The geographic locating system includes GPS processor 46, GPS receiver 42, and GPS antenna 44, and it is used to determine the exact location of the warning unit 20. The unit 20 is able to broadcast and receive military force information, such as location and status (i.e. friendly, unfriendly, unidentified statuses). An expert system military action advisory system and method for advising military troops or personnel of firing decisions is also disclosed. A firing index is determined based on the membership variables, and the firing index is used to help make the firing decisions. The membership variables and the firing index are defined for an expert system or fuzzy logic system, and the expert system or fuzzy logic system helps determine making the firing decisions. The system and method operate by transmitting target and friendly force GPS coordinate information to determine danger. Alternatively, only target coordinates are transmitted with fire danger indices calculated on a distributed basis by individual warning units and transmitted to the source of fire without friendly force location coordinates to assist in making final firing decisions.”

U.S. Ser. No. 12/465,715 discloses a combined IR-RF combat identification friend-or-foe (IFF) system for a ground targets, such as dismounted soldiers, vehicles or military platforms comprising IR-RF interrogator mounted on a firearm and IR-RF transponder mounted on a friendly target and further discloses: “RF channel operates in Ka-band providing brief information about friendly targets that could be in attacked area, and if they are, develop alert signal: “Friendly soldiers are in the area”. The interrogator additionally contains RF channel receiving reflected signal that allows recognize armed foe. IR channel of the system prevents friendly fire in the case of direct sighting to a friendly soldier.”

U.S. Pat. No. 6,664,915 discloses an identification friend or foe system for use by a weapon to determine whether a target that has been selected is a friendly target comprises a signal source attached to the target and arranged to radiate encrypted signals and further discloses: “A detection system attached to the weapon includes a receiver arranged to receive the encrypted signals when the weapon is within a predetermined range from the target. Signal processing apparatus is connected to the receiver and arranged to determine whether the encrypted signals identify the target as being friendly. The central processing unit is arranged to decrypt the encrypted signal and produce a disarm signal if the target is identified as being friendly. The central processing unit preferably is also arranged to produce a signal that causes the weapon to perform a collision avoidance maneuver to avoid colliding with the target if the target is identified as being friendly.”

The present invention discloses using the 405-415 kHz MF band. 405-415 kHz MF band is registered for radionavigation in all three regions of the Worldwide Spectrum Allocations, i.e. Region 1, Region 2 and Region 3.

### DESCRIPTION OF THE INVENTION

The following description is presented to enable any person skilled in the art to make and use the invention, and is provided in the context of particular applications of the invention and their requirements.

Security forces face the following problems in the field:
In every battle at least 2 percent of the soldiers are shot by allies or members of the same army, which is called friendly fire.
Some of the soldiers are not rescued because they are not found in the battle area.
In order to increase the rate of saving soldiers it is vital to obtain the information of the moment of the shooting and the location of soldiers.
While the soldiers are being rescued, prioritization cannot be made remotely according to the probability of being rescued.
Soldiers cannot understand whether their target is an ally or an enemy if their view is unclear or their target is behind a wall or any other object.
Ineffective operation of defense technologies in jammer areas.

The present invention discloses the following solutions to these problems:
Logging the positions of the soldiers by constantly monitoring them.
Receiving data of soldiers' heart rate and body temperature.
In case of a soldier is shot it is detected with the sensors and a rescue team is sent to the logged location.
The ability of the soldiers to understand with the sensors whether the target they are pointing their weapons at is an ally or a foe.
Military communication systems are not affected by jammers.

The present invention further discloses the product features below:
Heart Rate Info (Min Max Ex)
Body Temperature (Low/Over Temp)
Panic Run Info
Vest Damage Sensors (at 4 Different Point)
Drop Location Info
Emergency Button
ID Labeling
APCO Protocol Connteciton (Communication)
Bluetooth/Mobil Connection
Remote Sensor Access
Lightweight (max. 98 gr. Product Weight)
ID Code Sending (Automatic)

The product is composed of a master and one or more slaves.

The present invention further discloses the following technical specifications:
Ability to work with LR2032 or Battery (CR2) 24 Hour battery life
Not affected by jammers
Identifying the person behind the wall/object
Identifying the enemy or ally's distance behind the wall/object
Vibration notification if ally is nearby
Logging the date and data of se eing the ally
Low battery alert
Self Test
O,5 sn FX TX Pulse Rate
Inductive charging
Detect from 50 meter (radius) distance behind the wall

The present invention further discloses the following body warning system specifications:
Heart Rate Monitoring (Kardiac Pulse/IR Heart Rate)
Emergency Button (Locating)
Steel, Ballistic Vest Impact Sensor
Pulse Detection (G Sensor)
User Information (ID Code)
Compliance with Communication Data Protocols
Online Communication
Online Location Information, NMEA Code (CGGA)
Shooting Moment/Software Map Alarm Support
Minimum Product Weight
Wireless Charging (Universal USB)
Connection to Radio Sockets
User Opinion for Optimal Positioning

The present invention further discloses the following technical improvement steps:
Composite body
Longer battery time with Sleep Function
Auto Display (DIM) Function
ID (Non Contact) upload possibility (Operational)
Security in multiple sending (Frequency Hopping)
Warning on errors and confusions (No Syncron)
Increasing Pulse Intensity (Step up) increasing distance
Multi Gun a dapter.
Drop Test and IP Classification
Discrimination of Front, Back, Right, Left with multi sensors
SD routing indicators with LED
Examination of movements on the pan with software support
Examination of similar systems, if any
User tests
Vibration notification in silent environment
Shock proof structure (can be on body)

The present invention further discloses following technical features.

The present invention further discloses the inductive charging (wireless charging) of the device disclosed in this application. Inductive charging (wireless charging) of the device disclosed in this application is a technical advantage in the fast pace environment customary in the relevant military and civilian operations. Upon return from mission, or during waiting, for example, while the device is hung in the wardrobe, the battery will be charged inductively, i.e. without any sockets or cables, and the battery will be waiting ready for later use. In the prior art, while U.S. Pat. No. 8,169,185 mentions inductive charging and also mentions RFID tags, inductive charging (wireless charging) of the device disclosed in this application is novel in the art.

The present invention further discloses jammer proof operation. As previously disclosed in the present invention, the 405-415 KHz MF band is used. 405-415 kHz MF band is registered for radionavigation in all three regions of the Worldwide Spectrum Allocations, i.e. Region 1, Region 2 and Region 3. In the prior art, while U.S. Pat. No. 8,917,159 mentions jammers and also mentions RFID tags, jammer proof operation of the device disclosed in this application is novel in the art.

The present invention further discloses reflective glasses. The positions of the friends in the region will be reflected as text onto the inner mirror of the glasses when focused, thereby pereventing distraction. In the prior art, while U.S. Pat. No. 8,981,955 mentions reflective strips and also mentions RFID tags, the usage of reflective glasses in the device disclosed in this application is novel in the art.

The present invention further discloses real time processing of the user's orientation status, such as running, fallen, lying back, lying down. Each orientation status will be assigned a numeric value and this numeric value will be available to the central command, as well as to team members.

The present invention further discloses real time processing of impacts on various sensory points on the ballistic vest. Relevant information, such as “shot on the shoulder”, etc., will be available to the central command, as well as to team members.

The present invention further discloses that the positions of each team member (GPS) is available without a positioning system.

The present invention further discloses that the system is designed i) not to produce over weight or over volume, and ii) to be resistant against impact and water.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth.

Further it will be apparent to those skilled in the art that the objects of the present invention have been achieved by providing the above invention. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Therefore, the scope of the invention is to be determined by the terminology of the above description and the legal equivalents thereof.

1. An RFID based IFF identification system, wherein the identification system comprises:
a. a transponder that listens for an interrogation signal and then sends a response that identifies the broadcaster, and
b. the identification system uses the 405-415 kHz MF band, and
c. Heart Rate Info, and
d. Body Temperature, and
e. Panic Run Info, and
f. Vest Damage Sensors, and
g. Drop Location Info, and
h. Emergency Button, and
i. ID Labeling, and
j. APCO Protocol Connection, and
k. Bluetooth/Mobil Connection, and
l. Remote Sensor Access, and
m. Automatic ID Code Sending, and
n. a master and one or more slaves, and
o. LR2032 or Battery (CR2) 24 Hour battery life, and
p. Vibration notification if ally is nearby, and
q. Logging the date and data of seeing the ally, and
r. Low battery alert, and
s. Self Test, and
t. O,5 sn FX TX Pulse Rate, and
u. Inductive charging, and
v. Heart Rate Monitoring (Kardiac Pulse/IR Heart Rate), and
w. Emergency Button (Locating), and
x. Steel, Ballistic Vest Impact Sensor, and
y. Pulse Detection (G Sensor), and
z. User Information (ID Code), and
aa. Compliance with Communication Data Protocols, and
bb. Online Communication, and
cc. Online Location Information, NMEA Code (CGGA), and
dd. Shooting Moment/Software Map Alarm Support, and
ee. Wireless Charging (Universal USB), and
ff. Connection to Radio Sockets, and
gg. User Opinion for Optimal Positioning, and
hh. Composite body, and
ii. Sleep Function, and
jj. Auto Display (DIM) Function, and
kk. Non Contact ID upload possibility, and
ll. Frequency Hopping, and
mm. No Syncron, and
nn. Increasing Pulse Intensity, and
oo. Multi Gun adapter, and
pp. Drop Test and IP Classification, and
qq. Discrimination of Front, Back, Right, Left with multi sensors, and
rr. SD routing indicators with LED, and
ss. Examination of movements on the pan with software support, and
tt. Examination of similar systems, and
uu. User tests, and
vv. Vibration notification in silent environment, and
ww. Shock proof structure, and
xx. inductive charging, and
yy. reflective glasses, and
zz. real time processing of the user's orientation status, and
aaa. real time processing of impacts on various sensory points on the ballistic vest.
